(19) United States
(12) Patent Application Publication
(10) Pub. No.: US 2015/0112772 A1
(43) Pub. Date: Apr. 23, 2015

(54) INTERFACE AND METHODS FOR TRACKING AND ANALYZING POLITICAL IDEOLOGY AND INTERESTS

(71) Applicant: CROWDPAC, INC., Palo Alto, CA (US)

(72) Inventors: Adam BONICA, Palo Alto, CA (US); Steve HILTON, Atherton, CA (US); Kevin TWOHY, San Francisco, CA (US)

(21) Appl. No.: 14/512,217

(22) Filed: Oct. 10, 2014

Related U.S. Application Data
(60) Provisional application No. 61/890,168, filed on Oct. 11, 2013.

(51) Int. Cl. G06Q 10/10; G06F 17/30; G06Q 50/26

(52) U.S. Cl. CPC G06Q 10/10; G06Q 50/26; G06F 17/3053; G06F 17/30554
USPC 705/12

(57) ABSTRACT

Systems, processes, user interfaces, and computer readable media are described for scoring political entities on one or more political issues. In one example, the scoring is based on text data and political contribution data associated with the political entity. For example, a process may access or determine text data and financial contribution data associated with a political entity and then score the political entity to provide a measure of the political entity's ideology or position on one or more issues. Various graphical elements and interactive user interfaces can be generated based on various information derived therefrom. Users may search various political entities to view political entity scores, text data, financial data, issues, and the like, as well as enter their own political scores and/or issues to assist in identifying political entities.

### CROSS-REFERENCE TO RELATED APPLICATION

This application claims priority from U.S. Provisional Ser. No. 61/890,168, filed on Oct. 11, 2013, entitled INTERFACE AND METHODS FOR TRACKING AND ANALYZING POLITICAL IDEOLOGY AND INTERESTS, which is hereby incorporated by reference in its entirety for all purposes. This application is further related to U.S. Ser. No. [], filed concurrently herewith on Oct. 10, 2014, and entitled INTERFACE AND METHODS FOR TRACKING AND ANALYZING POLITICAL IDEOLOGY AND INTERESTS, which is hereby incorporated by reference in its entirety for all purposes.

### BACKGROUND

1. Field

The present disclosure relates generally to the field of measuring preferences and priorities of political entities (e.g., political candidates for elected office, political groups, political organizations, etc.), and more specifically, to providing an interface and system for collecting, analyzing, and predicting actions of political entities across various political issues.

2. Related Art

The onset and proliferation of web applications that help voters identify the party or candidate that best represents their policy preferences, commonly known as voter advice applications, is among the most exciting recent developments in the practice and study of electoral politics. After their emergence in the early-2000s, they quickly spread throughout Europe and beyond and have since become increasingly popular among voters. In recent elections in Germany, Netherlands, and Switzerland upwards of 30 to 40 percent of the respective electorates used these tools to inform their vote. Yet despite their growing popularity, voter advice applications have yet to make significant headway in the United States. While voter advice applications have excelled in parliamentary democracies which require data on the issue positions for a small number of parties, the multi-tiered, candidate-centered U.S. electoral system introduces challenges of size, scale, and complexity to the systematic provision of information.

Reformers have long advocated for greater disclosure and government transparency as a means to inform voters and enhance accountability. Thus, disclosure requirements have long been a central component of campaign finance regulation, churning out millions upon millions of records each election cycle. Yet despite the stringent disclosure requirements and reporting standards, making data transparent and freely available is seldom sufficient on its own. More is needed to translate this raw information into an informative resource for voters.

### SUMMARY

Systems and processes are described for scoring political entities (e.g., political candidates, parties, groups, organizations, etc.) on one or more political issues. In one example, the scoring is based on text data and political contribution data associated with the political entities. For example, a process may determine text data and financial contribution data associated with a political entity and then score the political entity to provide a measure of the political entity's ideology or position on one or more issues. Analysis of text data and financial contribution data associated with a political entity provides strong insight to the ideology and likely voting patterns of political entities. Voting and legislative data associated with the political entity may further be used (if available).

Various graphical elements and interactive user interfaces can be generated based on various information derived therefrom. Users may search various political entities to view political entity scores, text data, financial data, issues, and the like, as well as enter their own political scores and/or issues to assist in identifying political entities of importance. The exemplary processes and user interfaces may provide a user with a comprehensive voter guide and tool to learn about various political issues and political candidates.

Additionally, systems, electronic devices, graphical user interfaces, and non-transitory computer readable storage medium (the storage medium including programs and instructions for carrying out one or more processes described) for scoring political entities and providing various user interfaces are described.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary system and environment in which various embodiments of the invention may operate.

FIG. 2 illustrates an exemplary database architecture for use in certain examples.

FIGS. 3 and 4 illustrate exemplary screen shots of a user interface for displaying information relating to one or more political entities, including ideological ratings, priority issues, and contribution information.

FIG. 5 illustrates an exemplary process for scoring political entities based on at least text data and contribution data associated with the political entity.

FIG. 6 illustrates an exemplary table of top terms relating to issues, which may be used to manage data and prioritize issues, for example.

FIGS. 7 and 8 illustrate a series of parallel plots that compare ideological points generated from classical optimal classification and issue-specific optimal classification for the different sets of political entities.

FIGS. 9A-9C illustrate an exemplary user interface for a political entity.

FIG. 10 illustrates an exemplary user interface for a political issue.

FIG. 11 illustrates an exemplary user interface for a donation page based on a political issue.

FIG. 12 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

Internet-based voter advice applications have experienced tremendous growth across Europe in recent years but have yet to be widely adopted in the United States. By comparison, the candidate-centered U.S. electoral system, which routinely requires voters to consider dozens of candidates across a dizzying array of local, state, and federal offices each time they cast a ballot, introduces challenges of scale to the systematic provision of information. Various methods developed by political scientists to measure the policy preferences and expressed priorities of politicians can be adapted to help voters learn about candidates. For many of the same reasons they have proven useful to political scientists, there is significant value in retooling these quantitative measures of political preferences to a wider audience.

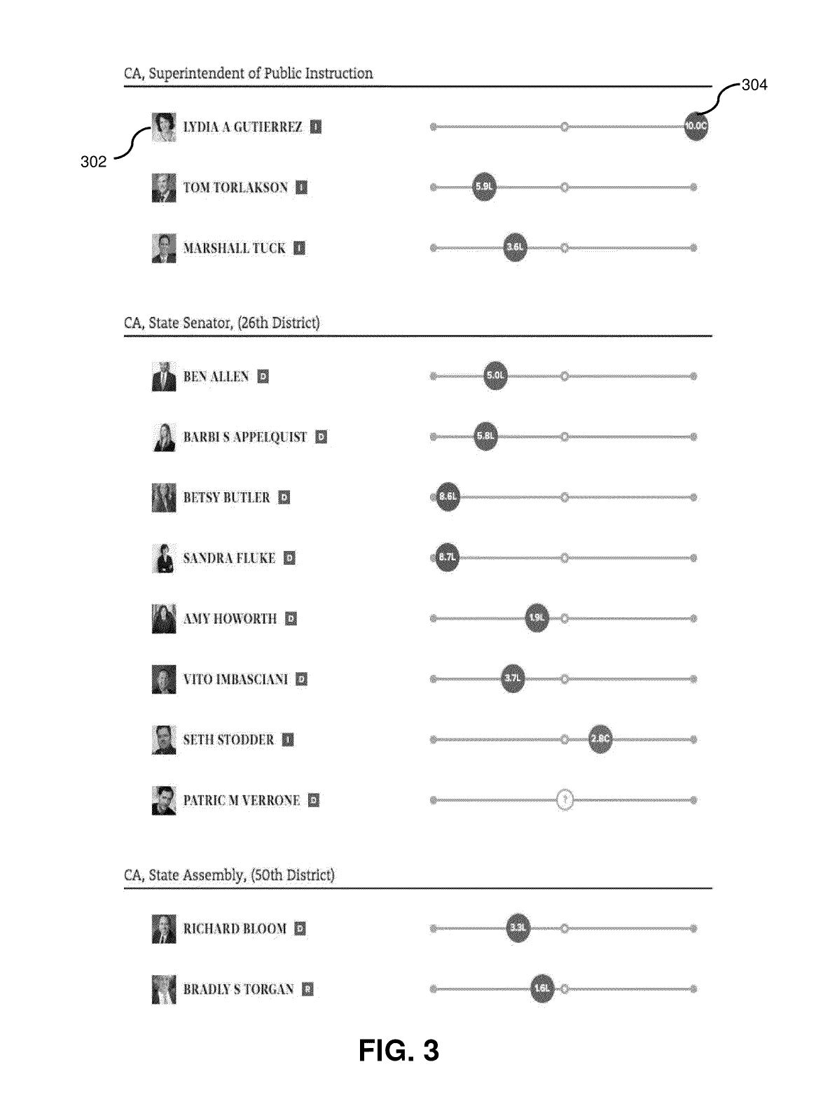

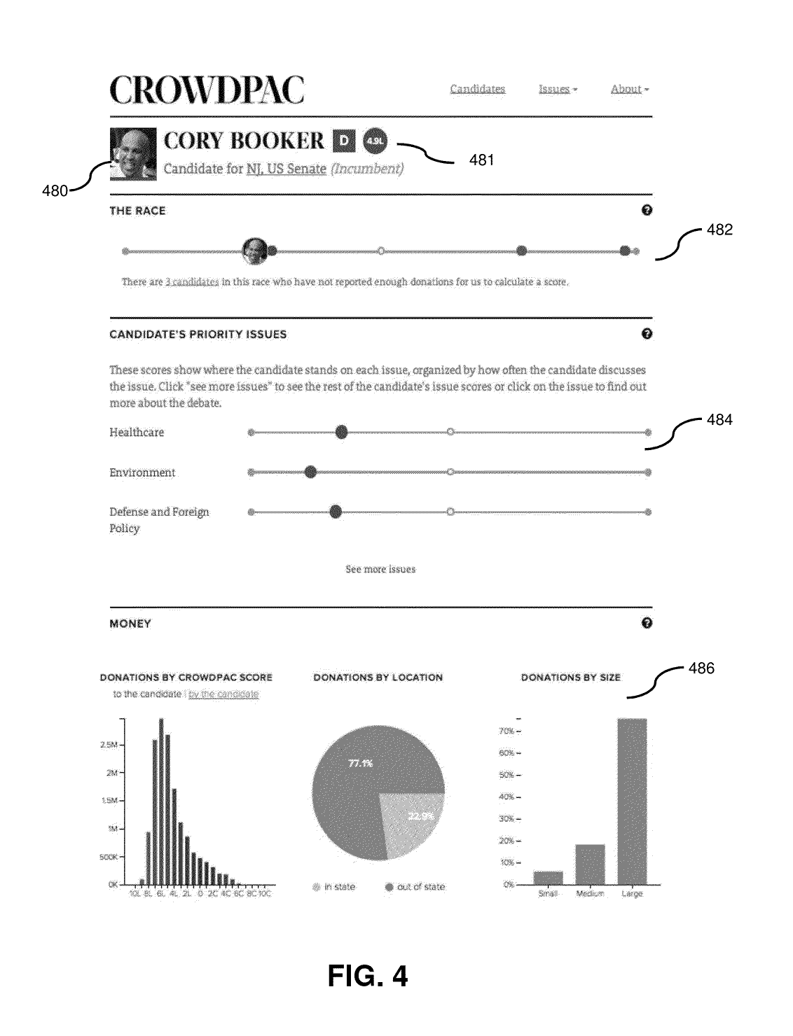

In one embodiment described herein, a set of tools for collecting, disambiguating, and merging large amounts of data on political candidates and other political entities is provided. Various statistical methods may be employed to measure the preferences and expressed priorities of politicians to aid voters in learning about candidates. These measures can then be searchable for display to a user via a user interface (e.g., a webpage) to show various data on political candidates, including their degree of conservatism or liberalism, priority issues, contribution sources, and so on. An exemplary interface is illustrated in FIGS. 3 and 4, which will be described in greater detail below. Such an interface may enable a user to quickly visualize different political candidates with respect to their political leaning and key issues to make more informed voting and/or contribution decisions.

Additionally, a user may enter information to help guide the user interface to return customizable information on political entities. For instance, a user can enter priority political issues they are concerned with, their own degree of conservatism or liberalism, and so on to aid in filtering the search results and providing more meaningful data and comparisons for the user. A user can further view an issue page, and, for example, view how a set of candidates fall on a particular issue. The user may further view contribution patterns to (or by) a political entity by (or to) other political entities, social connections (e.g., Facebook or LinkedIn friends), and the like.

### Exemplary Architecture and Scoring Process

According to one embodiment described herein, a database and modeling framework is described for quantitatively analyzing and scoring political entities. After an overview of an exemplary environment and database architecture of one embodiment are described (and automated data collection and entity resolution techniques used to build and maintain the database), a modeling framework developed to generate issue-specific ideal points that incorporates processes for analyzing political text, voting records, and campaign contributions is described.

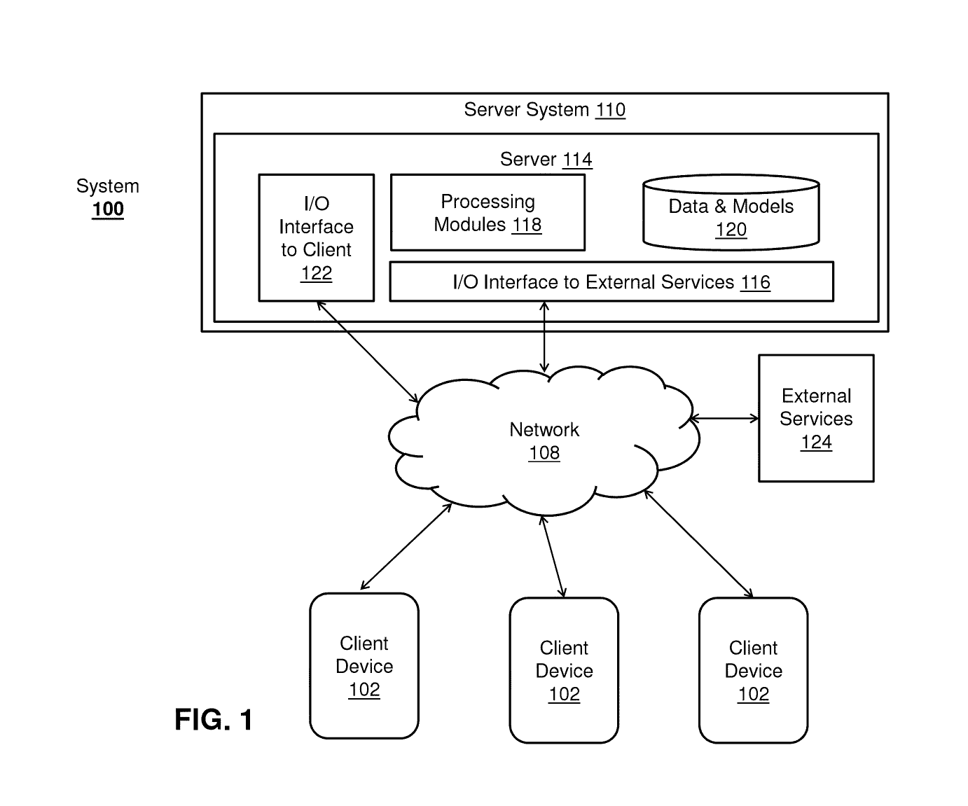

Initially, and with reference to FIG. 1, an exemplary environment and system in which certain aspects and examples of the systems and processes described herein may operate. As shown in FIG. 1, in some examples, the system can be implemented according to a client-server model. The system can include a client-side portion executed on a user device 102 and a server-side portion executed on a server system 110. User device 102 can include any electronic device, such as a desktop computer, laptop computer, tablet computer, PDA, mobile phone (e.g., smartphone), wearable electronic device (e.g., digital glasses, wristband, wristwatch, etc.), or the like.

User devices 102 can communicate with server system 110 through one or more networks 108, which can include the Internet, an intranet, or any other wired or wireless public or private network. The client-side portion of the exemplary system on user device 102 can provide client-side functionalities, such as user-facing input and output processing and communications with server system 110. Server system 110 can provide server-side functionalities for any number of clients residing on a respective user device 102. Further, server system 110 can include one or more political servers 114 that can include a client-facing I/O interface 122, one or more processing modules 118, data and model storage 120, and an I/O interface to external services 116. The client-facing I/O interface 122 can facilitate the client-facing input and output processing for political servers 114. The one or more processing modules 118 can include various issue and candidate scoring models as described herein. In some examples, political server 114 can communicate with external services 124, such as text databases, news feeds, subscriptions services, government record services, television programming services, streaming media services, and the like, through network(s) 108 for task completion or information acquisition. The I/O interface to external services 116 can facilitate such communications.

Server system 110 can be implemented on one or more standalone data processing devices or a distributed network of computers. In some examples, server system 110 can employ various virtual devices and/or services of third-party service providers (e.g., third-party cloud service providers) to provide the underlying computing resources and/or infrastructure resources of server system 110.

Although the functionality of the political server 114 is shown in FIG. 1 as including both a client-side portion and a server-side portion, in some examples, certain functions described herein (e.g., with respect to user interface features and graphical elements) can be implemented as a standalone application installed on a user device. In addition, the division of functionalities between the client and server portions of the system can vary in different examples. For instance, in some examples, the client executed on user device 102 can be a thin client that provides only user-facing input and output processing functions, and delegates all other functionalities of the system to a backend server.

It should be noted that server system 110 and clients 102 may further include any one of various types of computer devices, having, e.g., a processing unit, a memory (which may include logic or software for carrying out some or all of the functions described herein), and a communication interface, as well as other conventional computer components (e.g., input device, such as a keyboard/touch screen, and output device, such as display). Further, one or both of server system 110 and clients 102 generally includes logic (e.g., http web server logic) or is programmed to format data, accessed from local or remote databases or other sources of data and content. To this end, server system 110 may utilize various web data interface techniques such as Common Gateway Interface (CGI) protocol and associated applications (or “scripts”), Java® “servlets,” i.e., Java® applications running on server system 110, or the like to present information and receive input from clients 102. Server system 110, although described herein in the singular, may actually comprise plural computers, devices, databases, associated backend devices, and the like, communicating (wired and/or wireless) and cooperating to perform some or all of the functions described herein. Server system 110 may further include or communicate with account servers (e.g., email servers), mobile servers, media servers, and the like.

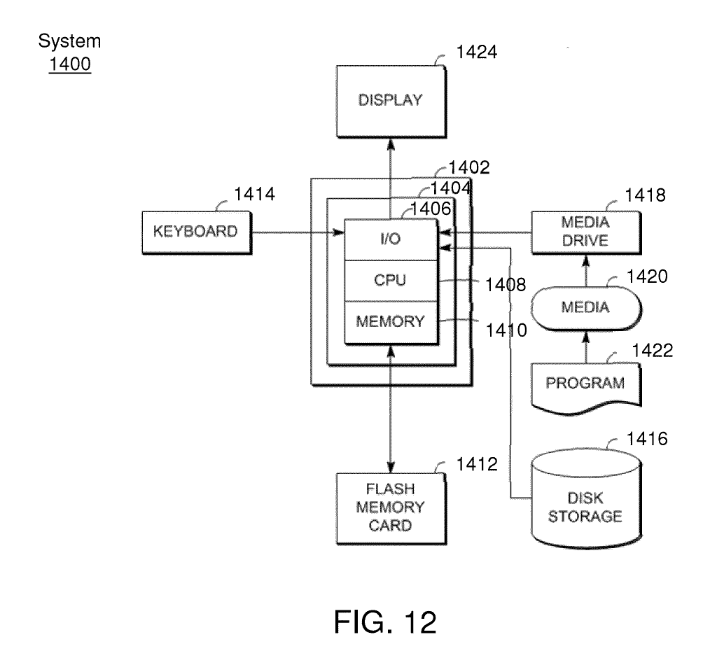

It should further be noted that although the exemplary methods and systems described herein describe use of a separate server and database systems for performing various functions, other embodiments could be implemented by storing the software or programming that operates to cause the described functions on a single device or any combination of multiple devices as a matter of design choice so long as the functionality described is performed. Similarly, the database system described can be implemented as a single database, a distributed database, a collection of distributed databases, a database with redundant online or offline backups or other redundancies, or the like, and can include a distributed database or storage network and associated processing intelligence. Although not depicted in the figures, server system 110 (and other servers and services described herein) generally include such art recognized components as are ordinarily found in server systems, including but not limited to processors, RAM, ROM, clocks, hardware drivers, associated storage, and the like (see, e.g., FIG. 12, discussed below). Further, the described functions and logic may be included in software, hardware, firmware, or combination thereof.

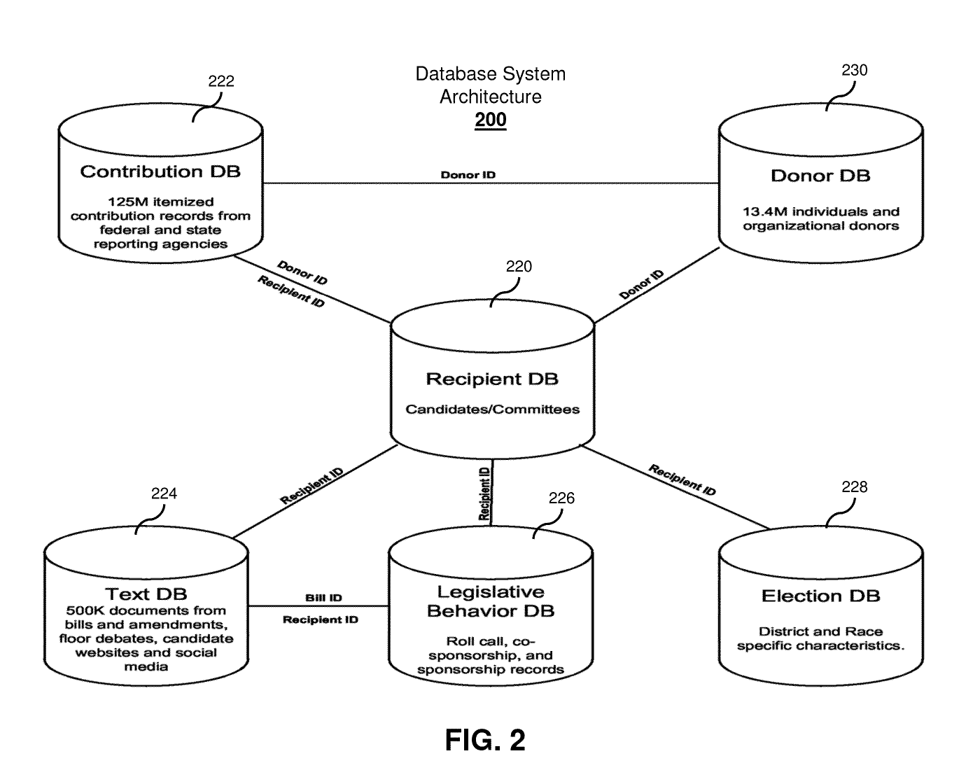

FIG. 2 illustrates a detailed example of a database system 200 in which various aspects of exemplary processes to measure and score political entities may use. Components of database system 200 may be included with server system 110, political server 114, or remotely thereto, e.g., as external services 124 (as shown in FIG. 1). In one embodiment, the system draws on three main sources of data: text, voting and legislative behavior (if available), and campaign contributions (to and/or from a political entity), which are generally indicated by text database 224, legislative behavior database 226, and contribution database 222, respectively.

In one example, each data source utilizes automated scrapers to collect and process new data from databases or websites as it becomes available. In order to enhance scalability, as a new data source is included or associated with the database system, that data source can be vetted for its ability to be maintained with minimal human supervision. Beyond automating the process of compiling and updating the database, transforming the raw data into useable format may also be needed. In particular, merging and disambiguating data drawn from difference sources is typically required. This can be managed with automated identity resolution and record-linkage algorithms supplemented by strategic use of human-assisted coding when identifying personal contributions made by candidate.

With regard to text data, and in one particular example, the bulk of text data can be sourced from documents from Congressional bill text and Congressional Record documents. Congressional bill text can be scraped from thomas.gov, for example. Additional contextual data on legislation, such as information on sponsorship, cosponsorship, and committee activity, may also be collected. Importantly, the Congressional Research Service (CRS) provides subject codes for each bill. These tags can be used to train the topic model discussed in greater detail below. The Congressional Record, which contains transcripts of all proceedings, floor debates, and extensions of remarks for Congress, can be scraped from the GPO's Federal Digital System (FDsys). Additional text for current candidates can be scraped from campaign webpages, social applications (e.g., Twitter and Facebook accounts), speech transcripts, print articles, books, and so on. Each document in the text database 224 can be linked to a candidate ID and, when applicable, a bill ID. Further, bill authorship can be assigned to the sponsor(s), and speeches made during floor debates can be linked to the legislation under debate. Additional information that records the date, originating corpus, and source location of the document is also recorded in the text database 224 (and/or the legislative behavior database 226).

With regard to voting and legislative behavior, in one example, congressional voting records can be scraped from voteview.com using the wnominate R package (see, e.g., “Scaling Roll Call Votes with wnominate in R,” Poole, Keith, Jeffrey Lewis, James Lo, and Royce Carroll, Journal of Statistical Software 42 (14): 1-21 (2011), which is incorporated herein by reference in its entirety). For instance, bills and amendments are typically assigned unique identifiers that link them to their corresponding text. The process of scraping voting records for state legislatures can be automated, and added to the legislative behavior database 226, for example.

With regard to campaign contributions, in one example, contribution records can be pulled from an augmented version of the Database on Ideology, Money, and Elections, Bonica (2014) (see http://data.stanford.edu/dime to access the database and reference documentation), which is incorporated herein by reference in its entirety. This database generally collects data from state and federal campaign finance disclosure sources and processes the records using entity resolution algorithms (of course, other databases may be used instead of or in addition to this one). As nearly every serious candidate for state and federal office engages in fundraising (either as a recipient or donor), in one example, campaign finance data provides the scaffolding for constructing the recipient database 220.

The exemplary database architecture of FIG. 2 includes six tables corresponding to different record types. Further, unique identifiers for candidates, donors, and bills serve as crosswalks (e.g., references or links) between the tables. The lines in FIG. 2 between databases generally indicate the existence of a crosswalk between two tables. It should be understood, of course that various tables may be included in a single database system or spread across two or more database systems. Further, various tables and database may be co-located or remotely located. Further, certain data may be accessed or requested in response to queries (that is, the records or table need not reside or always be accessible to a particular database or server carrying out query requests).

In this exemplary database structure, the recipient table 220 plays a central role in structuring the data. It can be mapped onto each of the other databases by one or more crosswalks. It contains variables for numerous characteristics of political entities, including the office sought, biographical profiles, past campaigns and offices held, fundraising statistics (e.g., totals by source, amount raised from donors within the district, etc.), committee assignments, and various other data rendered on the site. For instance, each row may represent a candidate-cycle observation. In one example, a recipient table includes rows extending back many years (e.g., back to the 1970s), covering hundreds of thousands of distinct candidates and political committees. For candidates who have run for multiple offices (e.g., for both state and federal offices), additional identity resolution processing can be applied to assign each candidate a unique identifier.

The contribution database 220 can include itemized contribution records made, for example, to state and federal elections. In one example, this table includes over 125 million records. Each record can map onto the recipient database 220 via a corresponding recipient ID. Contribution records can also be linked to the originating candidate or committee for the set of recipients who have donated via the contributor IDs. The donor table 230 summarizes and standardizes information contained the contribution database 222 into a more useable format with a single row per donor.

The text database 224 can include documents associated with political candidates and can be scraped from legislative text for bill and amendments, floor speeches, candidate webpages, social media accounts, and so on. Every document can be linked to one or more of a candidate from recipient table 220, a bill or amendment from the legislative table 226, or, in the case of sponsored legislation, both.

Additional information, which is generally district and/or race specific, can be accessible from election database 228. For example, election database 228 may organize candidates into specific electoral contests. It may also include information on electoral districts such as previous presidential vote share outcomes and the like.

Taken together, the databases provide data for the exemplary models to drive a user interface accessible via, e.g., a website. A single database query can return a wealth of information on a candidate, including information on their ideology, fundraising activity and donors, their personal donation history, sponsored and cosponsored legislation, written and spoken text, voting records, electoral history, personal and political biographies, and more.

### Models for Analyzing Data

According to one embodiment described herein, exemplary processes are provided for identifying key topics and scoring political entities on such topics. Further, processes for scoring a political entity to determine priority issues for the political entity, as well as their predicted leaning or preferences with respect to different issues, is provided. The model generally digests political text, legislative voting, and campaign contributions (both to and from a political entity) for scoring political entities.

Methods to measure ideology have generally relied on legislative voting records, which precludes generating ideological points for non-incumbent candidates and most other non-legislative office holders. The model used here to generate scores for candidates overcomes this problem, in one example, by scaling campaign contributions using the common-space DIME methodology (Database on Ideology, Money, and Elections, Bonica, 2014, see http://data.stanford.edu/dime to access the database and reference documentation, which is incorporated herein by reference in its entirety). The measurement strategy relies on the donors' collective assessments of candidates as revealed through donation patterns. By seeking out candidates that share their policy preferences among the multitudes of the political marketplace, donors offer a way to learn about candidates and predict how they would behave if elected to office. An advantage of using campaign contributions is that this data typically provides measures for a much broader range of candidates, including non-incumbent candidates that have not previously held elected office, reaching much further down the ballot.

Other advantages of this measurement strategy include its inclusiveness and scalability. For example, a process of generating scores for many thousands of candidates appearing on the ballot can be largely automated, making it possible for the efforts of a small team to scale in order to cover a comprehensive set of candidates for state and federal offices (as opposed to covering merely the top 2 or 3 candidates). This can been seen in FIG. 3, which displays a screenshot that captures three of the eleven primary races appearing on a sample ballot Voter Guide for the 2014 California Primary Elections. In this example, each candidate 302 in the contest is assigned an overall ideological score 304 ranging from “10L”, for candidates on the far left, to “10C”, for candidates on the far right. The scores are rescaled in order to enhance interpretability for users. The rescaling function is identified using the historical averages for the parties in Congress over the past two decades. First, the historical party means are calculated by aggregating over the ideal points of the members from each party serving in each Congress between 1992 through 2012. The scores are then rescaled such that the midpoint between the party means is set to 0 and the historical party means are positioned at 5L and 5C. Consequently, the extreme values of 10L or 10C means are identified as the points where the historical party means are equidistant from the midpoint.

It will be understood by those of skill in the art that other scoring methodologies are possible, e.g., ranging from a minus maximum to a positive maximum (without political right/left designations), a percentage score (e.g., of agreement or disagreement with an issue), and so on.

In one example, for the model to generate a score, a candidate must either (1) receive contributions from at least two donors who have also given to other campaigns or committees, or (2) personally contribute to at least one other candidate with a score from the model. As most candidates meet both criteria, they are assigned scores as recipients and as donors. In one example, donor scores are estimated independently of the recipient scores and exclude any contributions made to one's own campaign. Nonetheless, there is typically a strong correspondence between the two sets of scores. For example, for the 1,638 federal candidates running in the 2014 Congressional elections that have scores as both donors and recipients, the correlations between contributor and recipient ideal points are ρ=0.97 overall, ρ=0.92 among Democrats, and ρ=0.94 among Republicans. In addition, a third set of ideal point estimates are available candidates who have served in Congress based on roll call voting records.

Given the availability of multiple measures of candidate ideology, the model may average over information from each set of scores. In order to average over scores, a multiple-imputation framework designed to handle multiple continuous variables with measurement error and missing data may be employed; for example, as described by (“Multiple Overimputation: A Unified Approach to Measurement Error and Missing Data,” Blackwell, Matthew, James Honaker, and Gary King, Overview, Sociological Methods and Research, http://j.mp/jqdj72 (2010), the contents of which are incorporated herein in their entirety by reference). In one example, five sets of scores may be input and principle component analysis run separately on each dataset. The overall scores may then be calculated by averaging over candidate scores from the first dimension recovered in each of the runs. The averaged scores typically correlate with the recipient scores at ρ=0.99, the contributor scores at ρ=0.99, and the roll call scores at ρ=0.94.

In some examples, more inquiring users are given the option to further explore the data by clicking through to the “data details” pages provided for each candidate. FIG. 4 displays an exemplary screenshot for the data details page for an exemplary candidate 480, along with their overall political score 481. The module 482 on the top displays the candidate's ideological score with respect to his opponents in the upcoming election, where each of the other “dots” on the scale may be selectable to view the opponent's data page. While the voter guide makes extensive use of scores along a liberal to conservative dimension, issue-specific ideal points are also available, e.g., as shown in module 484. In one example, issue-specific ideal points are made available for a large percentage of candidates who meet a minimum data requirement of raising funds from at least 100 distinct donors who have also donated to one or more other candidates. These scores are generated using a model described below that combines political text, legislative voting records, and campaign contributions.

The bottom modules 486 summarize the candidate's fundraising activity by showing the distribution of ideal points of donors to his campaign along with other general fundraising statistics. For candidates who have made personal donations to other candidates and committees, there is a toggle option that shows the ideological distribution of the recipients weighted by amount. Other modules not shown, but which may be included, are (1) a visualization of the candidates fundraising network accompanied by a listing of the candidate's nearest neighbors (i.e., donors who gave to the candidate also gave to candidates X, Y, Z), (2) a summary the candidate's text showing their expressed priorities and a word cloud of top terms, (3) a video of the candidate from YouTube™ or similar video sharing services, (4) biographical information including past political experience and offices held, (5) and for sitting members of Congress, a summary of recent voting behavior and interest group ratings.

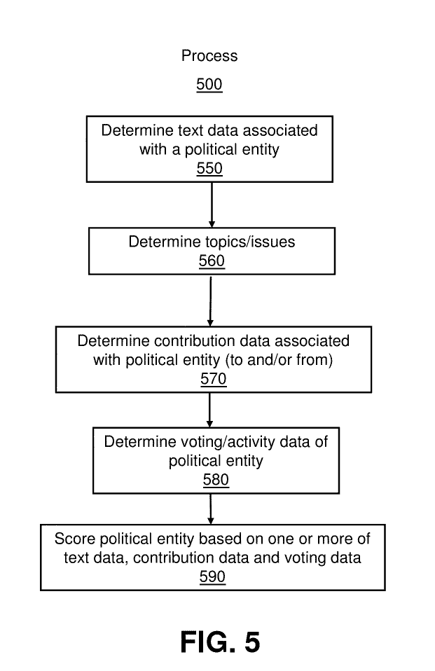

FIG. 5 illustrates broadly an exemplary process 500 for determining priority issues and generating ideology scores and issue scores across a range of issue-areas for political entities based on text, political contributions, and past voting records. The exemplary process may rely on the system and architecture described above, and may further include the specific modeling and training techniques described below.

At 550, text data associated with a political entity is determined or accessed. For example, data from congressional records, speeches, political websites, articles, and so on can be collected and associated with different political entities. At 560, the text data can be used to determine various political issues, e.g., tagging or otherwise identifying topics or issues. In some examples, the issues can be manually entered and used to filter or assign text data records. In other examples, issues or topics can be generated automatically by an analysis of the data records (exemplary models and processes for identifying issues are described in greater detail below).

At 570, contribution data can be determined or accessed, the contribution data associated with the political entities. In one example, the contribution data is associated with the identity of the donor, recipient, amount, donor history, and related data, which may include other recipients, associated organizations, and so on. Various models and processes for evaluating contribution data are described in greater detail below.

At 580, if available, voting history and activity of political entities can be determined. For example, records of past voting history on different issues, bill sponsorships, committees, and other activity data can be collected or accessed. In some examples, however, a political entity may not have a voting record, so this act can be omitted.

At 590, based on at least the text data (550) and contribution data (570), one or more political entities can be scored generally or on one or more issues (e.g., identified at 560). Further, to the extent available, the scoring may further incorporate voting and/or activity data (580). Various exemplary scoring methods may be employed, based on the text data and contribution data, to score political candidates relative to each other on one or more issues.

More detailed examples for performing the above process(es) will now be described. In one embodiment, a model is provided to determine priority issues and generate issue scores across a range of issue-areas for political candidates based on text, political contributions, past voting records, and so on. Additionally, a process is provided to train a model to predict issue scores for a wider set of candidates by conditioning on shared sources of data. In the following exemplary modeling strategy, topic modeling, ideal point estimation, and machine learning methods are combined.

In one example, a topic model for political text is estimated using a partially labelled dirochlet allocation (PLDA) model (which is described in greater detail, e.g., in “Partially labeled topic models for interpretable text mining,” Ramage, Daniel, Christopher D Manning, and Susan Dumais, Proceedings of the 17th ACM SIGKDD International Conference on Knowledge Discovery and Data Mining, ACM pp. 457-465 (2011), the contents of which are incorporated herein by reference in their entirety). The PLDA model is a partially supervised topic model designed for use with corpuses where topic labels are assigned to documents in an unstructured or incomplete manner. The PLDA produces two useful sets of estimates. The first is a set of topic loadings for bills. The second is a set of measures of the expressed issue priorities for candidates (which is described, e.g., in “A Bayesian hierarchical topic model for political texts: Measuring expressed agendas in Senate press releases,” Grimmer, Justin, Political Analysis 18 (1): 1-35, (2010), the contents of which are incorporated herein by reference in its entirety).

For each bill introduced, the Congressional Research Service (CRS) assigns multiple issue labels. The CRS labels are typically not well structured or assigned based on a systematic coding scheme. For example, the raw data currently includes a total of 4,386 issue codes, and it is not uncommon for bills to be tagged with a dozen or more labels by coders. Many of these issue codes are overly idiosyncratic (e.g. “dyslexia” and “grapes”), closely related or overlapping (e.g. “oil and gas”, “oil-well drilling”, “natural gas”, “gasoline”, and “oil shales”), or sub-categorizations. In order to simplify the issue labels, a layer of normalization can be applied on top of the CRS issue codes. This can be done by mapping issue labels onto a more general set of categories. CRS issue labels that overlap two larger categories are tagged accordingly, e.g., minority employment [symbol] civil rights and jobs and the economy. CRS issue labels that are either too idiosyncratic (e.g. “noise pollution”) or too ambiguous (e.g. “competition”) to cleanly map onto one or more of the categories can be removed. All other documents, including those scraped from social media feeds and candidate websites, can be used during the inference stage.

Floor speeches can be scraped from the congressional record and organized into documents based on the identity of the speaker and, if applicable, the legislation under debate. A parser can then extract the speaker's identity, filter on the relevant body of text, and link floor speeches to bill numbers. In order for a document to be linked to a legislator, the bill number must be included somewhere in the heading or the speaker must directly reference the name or number of the legislation in the text. Of course, not all floor speeches are connected to legislation. Legislators are routinely given the opportunity to make commemorations or address an issue of their choosing not necessarily in reference to any legislation. These speeches often are used as position-taking exercises and are thus informative signals about the legislator's expressed priorities.

The training set for the topic model may include all documents that can be linked to legislation with CRS issue tags. As the CRS issue tags are derived from the content of the legislation, bills are useful when training on the CRS labels. Documents that contain floor speeches made in relation to a specific bill, usually as part of the floor debate, are also included as part of the training set. This assumes that the CRS categories assigned to a bill also applies to its floor debate. As such, the topic loadings for a bill can reflect both the official language of a bill and the language members say in support or opposition. This is done to allow for a more rounded account in variation in how legislators frame their understanding a bill and the concerns they emphasize. For example, the legislative text of a bill relating to health care is likely to predominantly fall within the health care topic, but the speeches made in opposition during the floor debate might strongly emphasize a single paragraph relating to reproductive rights. Accordingly, the coding scheme can take this into account.

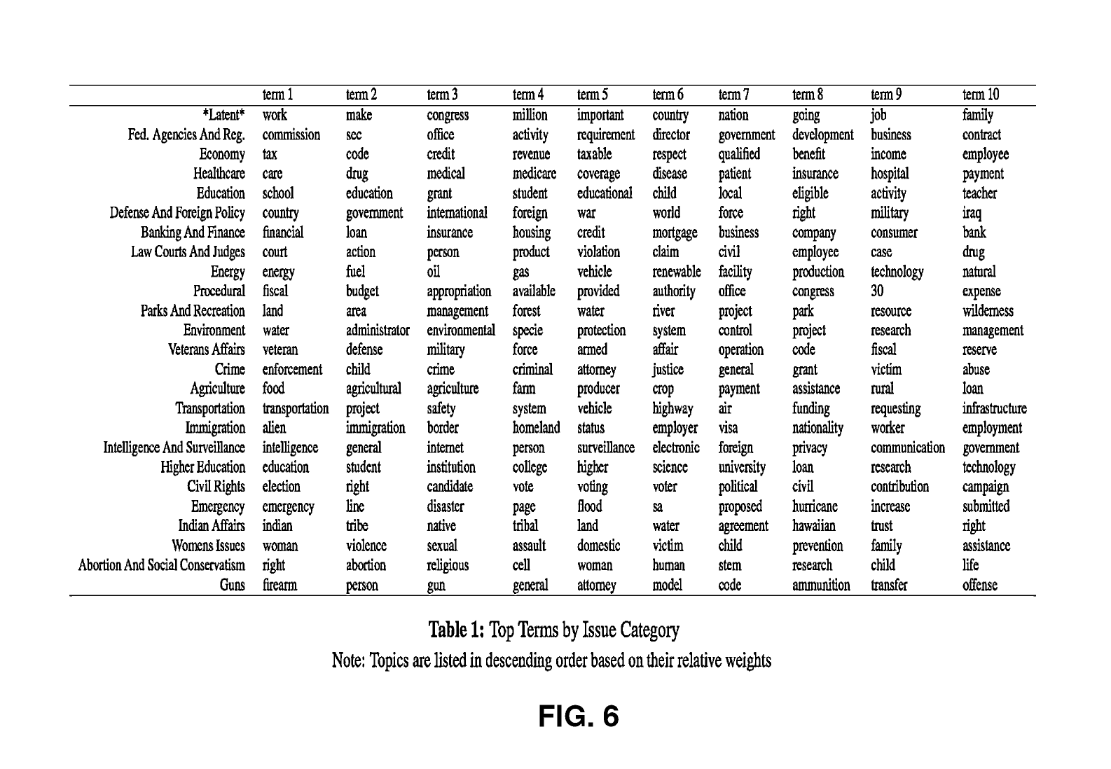

In one example, the PLDA model is fit using the Stanford Topic Model Toolkit (e.g., as described in “Topic modeling for the social sciences,” Ramage, Daniel, Evan Rosen, Jason Chuang, Christopher D Manning, and Daniel A McFarland, NIPS 2009 Workshop on Applications for Topic Models: Text and Beyond. Vol. 5. (2009), which is incorporated by reference in its entirety). In addition to the specified issue categories, the model allows for a latent category which acts as a catch-all or background category. The model can be fit with unigrams. In addition to the typical list of stopwords included in the nltk python package, several terms specific to congressional proceedings and legislation can be removed from the text. Stemming can also be performed using the WordNet lemmatizer again provided by ntlk python package. Rare terms, e.g., found in fewer than 100 documents, may be filtered out. Documents that did not meet a minimum threshold, e.g., of ten terms, can be excluded. The model may be iterated many times, e.g., 5,000 times, to ensure convergence. FIG. 6 (Table 1) illustrates an exemplary result of top terms by issue, where topics are listed in descending order base on their relative weights.

In some examples, an issue-specific optimal classification scaling model can further be employed. A non-parametric optimal classification scaling model is generally attractive for this application because of its computational efficiency, robustness to missing values, and ability to jointly scale members of the House and Senate in a common-space by using those who served in both chambers as bridge observations. The model builds on multidimensional ideal point estimation (see, e.g., “The Supreme Court's Many Median Justices,” Clark, Tom S., and Benjamin Lauderdale, American Political Science Review 106 (847-66) (2012); “How they vote: Issue-adjusted models of legislative behavior,” Gerrish, Sean, and David M Blei, Advances in Neural Information Processing Systems, pp. 2753-2761 (2012); and “Scaling Politically Meaningful Dimensions Using Texts and Votes,” Lauderdale, Benjamin, and Tom S. Clark, American Journal of Political Science (2014), all of which are incorporated herein by reference.).

Generally, the dimensionality of roll calls can be identified using a topic model trained on issue tags provided by the CRS. The issue-specific OC model differs in its approach to mapping the results from the topic model onto the dimensionality of roll calls. For example, classical OC incorporate a vector issue adjustment parameters which in effect serve as dimension specific utility shocks. The issue-specific OC model instead utilizes the basic geometry of spatial voting through the parameterization of the normal vectors. This approach distinguishes the issue-specific OC model from Clark and Lauderdale (2012) who similarly extend OC to generate issue-varying ideal points for U.S. Supreme Court Justices by kernel-weighting errors based on substantive similarity.

In the classical OC model, the dimensionality of bill j is determined by a heuristic cutting plane algorithm that searches the parameter space for the normal vector Nⱼ and corresponding cutting line cⱼ that minimize classification errors. The issue-specific OC model of this example instead differs by calculating the normal vectors based on the parameters recovered from the PLDA model. Given a k-length vector λⱼ of topic weights for roll call j, the normal vector is calculated as

$${N}_{jk} = \frac{{λ}_{jk}}{\vert \vert {λ}_{j} \vert \vert} .$$

Legislator ideal points are then projected onto the projection line: wᵢ=θ′ᵢNⱼ. Given the mapping onto w, finding the optimal cutting point cⱼ is identical to a one-dimensional classification problem. Given the estimated roll call parameters, issue-specific ideal points can be recovered dimension by dimension. Holding parameters for θᵢ₋ₖ constant, classification errors are minimized by finding the optimal value of θᵢₖ given cⱼ and the projected values wᵢⱼ=θ′ᵢ₋ₖNⱼ₋ₖ+θ′ᵢₖNⱼₖ. As an identification assumption, θₖ₌₁ is fixed at its starting value.

In one example, a further extension to the OC model includes the incorporation of kernel methods to capture the relative importance of bills to legislators. When a member sponsors a bill or contributes to the floor debate, it suggests that the bill has greater significance to her than other bills on which she is silent. The inputs to the kernel-weighting function are status as a sponsor or co-sponsor, and the total word-count devoted to the legislation. The weight matrix is constructed as follows:

ωᵢⱼ=1+γ₁sponsorᵢⱼ+γ₂cosponsorᵢⱼ+γ₃ log(wordcountᵢⱼ) (1)

The γ parameters may be calibrated using a cross-validation scheme. Given a set of parameter values, the model can be subjected to repeated runs with a fraction of observed vote-choices held-out. After the model run has converged, the total errors can be calculated for held-out sample based on the recovered estimates. Values are typically somewhere in the region of γ₁=5, γ₂=2, and γ₃=1.

Starting values can be estimated separately for each dimension using a one-dimensional OC scaling with issue-weighted errors. Given an issue dimension k, errors on each roll call are weighted by the proportion of the related text associated with the issue. A classification error on a roll call where λⱼₖ=0.5 is weighted 50 times that of an error on a roll call where λⱼₖ=0.01. After dropping roll calls where λⱼₖ<0.01, the model is run to convergence.

Table 2 reports the classification statistics for the issue-specific OC model. The issue-specific model increases correct classification over the one-dimensional model but only marginally. Congressional voting has become so unidimensional that only a small fraction of voting behavior is left unexplained by a one-dimensional model. The issue-specific model explains a non-trivial percentage of the remaining error. However, this is slightly less than the reduction in error associated with adding a second dimension to the classical OC model.

TABLE 2
Correct Classification (CC) and Aggregate
Proportional Reduction in Error (APRE)

| | | | | Weighted | Weighted | Weighted |
|---|---|---|---|---|---|---|
| | CC | APRE | Errors | CC | APRE | Errors |
| One- | 0.936 | 0.825 | 154569 | 0.938 | 0.818 | 179598 |
| Dimen- | | | | | | |
| sional | | | | | | |
| OC | | | | | | |
| Issue- | 0.940 | 0.835 | 145430 | 0.943 | 0.832 | 166126 |
| Specific | | | | | | |
| OC | | | | | | |

The marginal increase in fit is largely by design and is explained by constraints built into the exemplary issue-specific OC model. Classifying roll call votes in multiple dimensions can be highly sensitive to slight changes to the position or angle of the cutting line. The cutting-plane search is free to precisely position the cutting line by simultaneously manipulating the normal vector and cutting-line. Hard coding the dimensionality of bills based on the topic loading constrains normal vectors and limits the search to cⱼ. This is further compounded by a modeling assumption, made largely out of the interest of reducing computational costs, that constrains the values for Nⱼₖ>0, corresponding to the vector of topic loadings for each bill from which they are calculated. This means that bill proposals move policy on all relevant dimensions in the same direction (i.e., towards the ideological left or right). That is, the exemplary model does not allow for a bill to move economic policy to the right but immigration policy to the left. (For a two-dimensional model this would constrain the normal vector to the upper-right quadrant. This constraint could be relaxed by the addition of a sign vector that would allow values in the normal vector to take on negative or positive values.)

As a way to assess the extent to which holding the normal vectors fixed explains the marginal reduction in error, the cutting-plane search algorithm can be run with the legislator ideal points set at values recovered from the issue-specific model. Relaxing the constraint on the normal vectors results in an appreciable reduction in error, boosting correct classification to 96.4 percent.

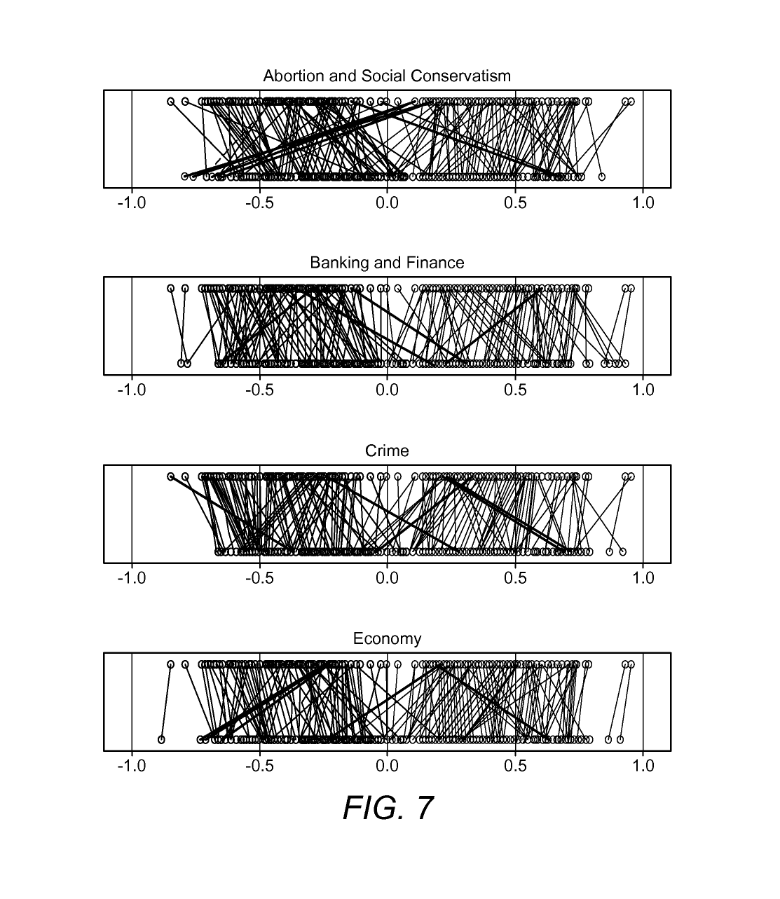

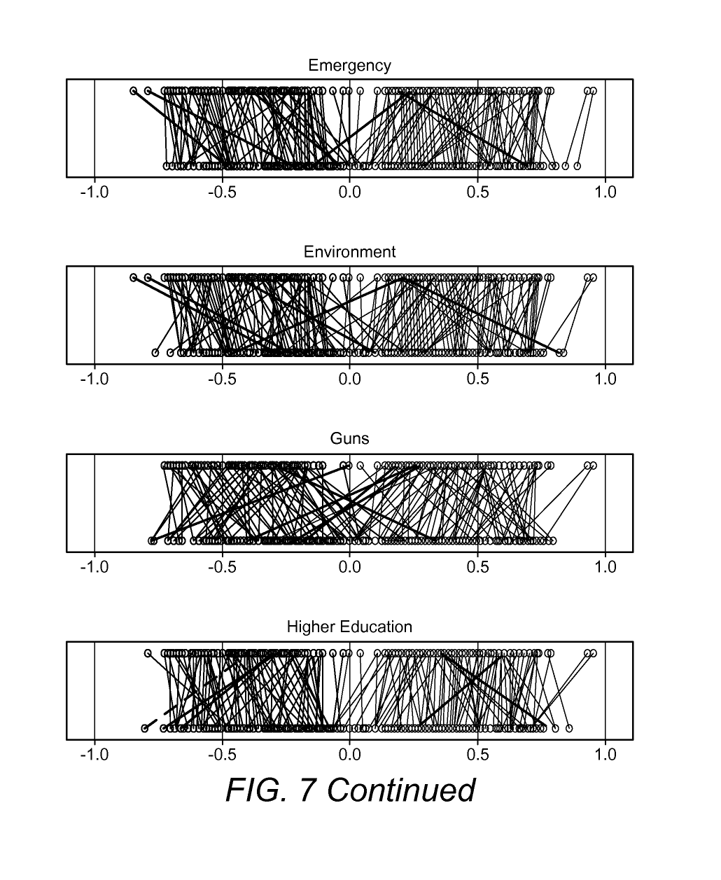

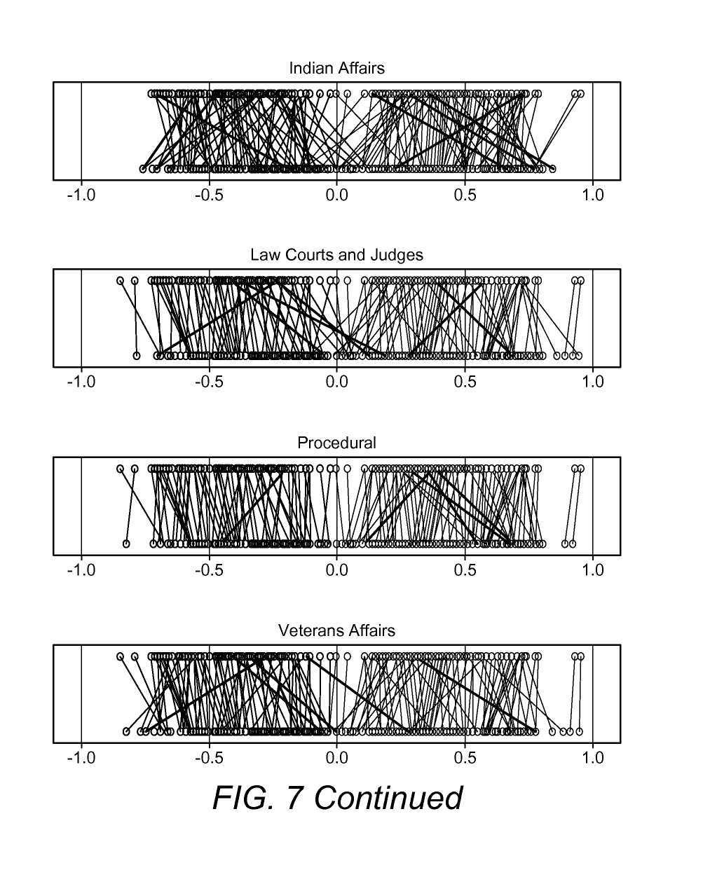

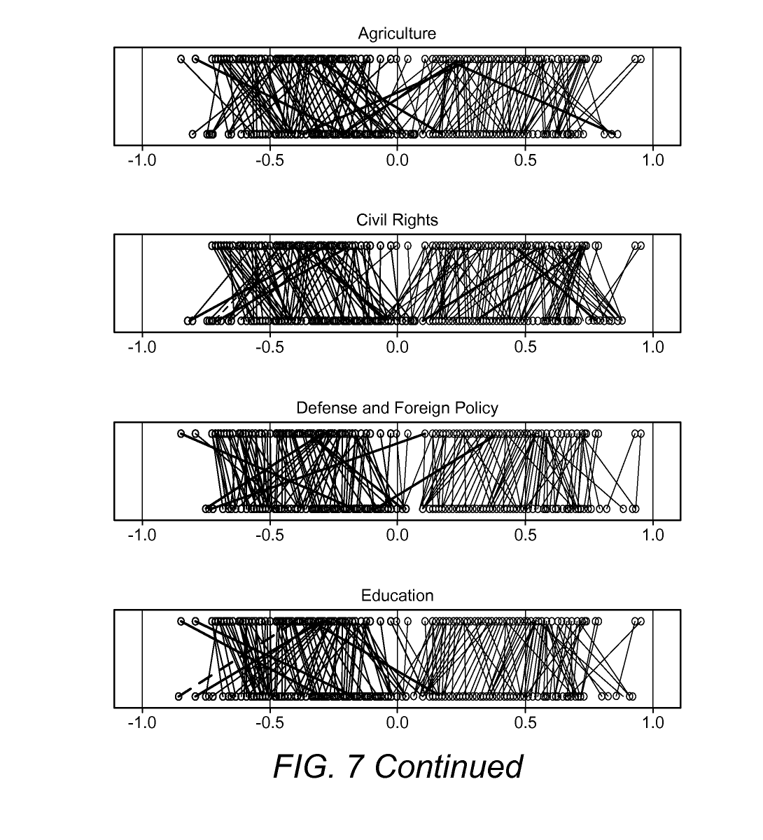

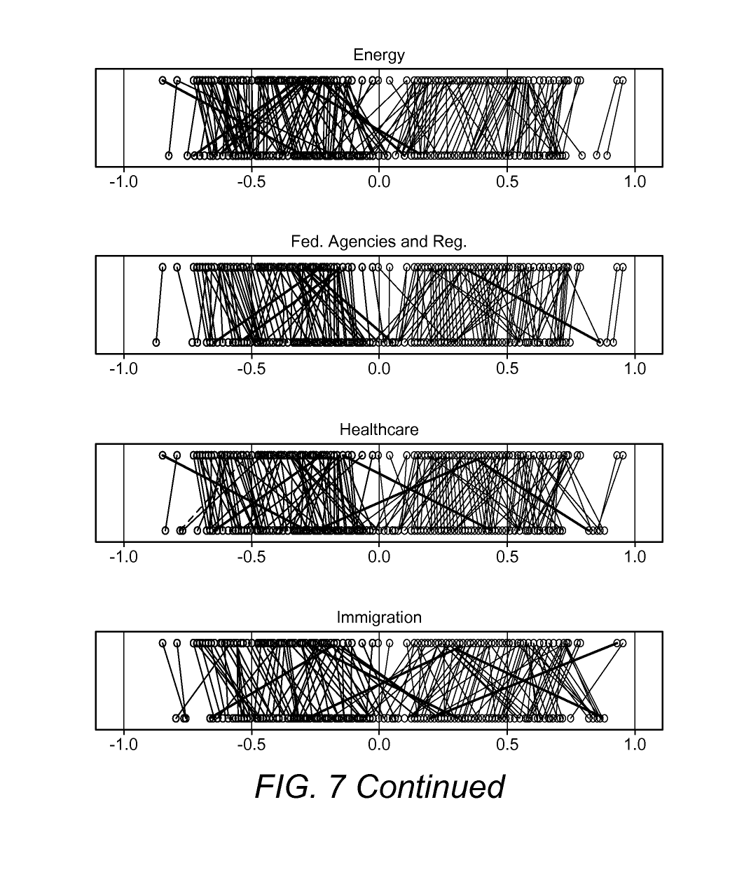

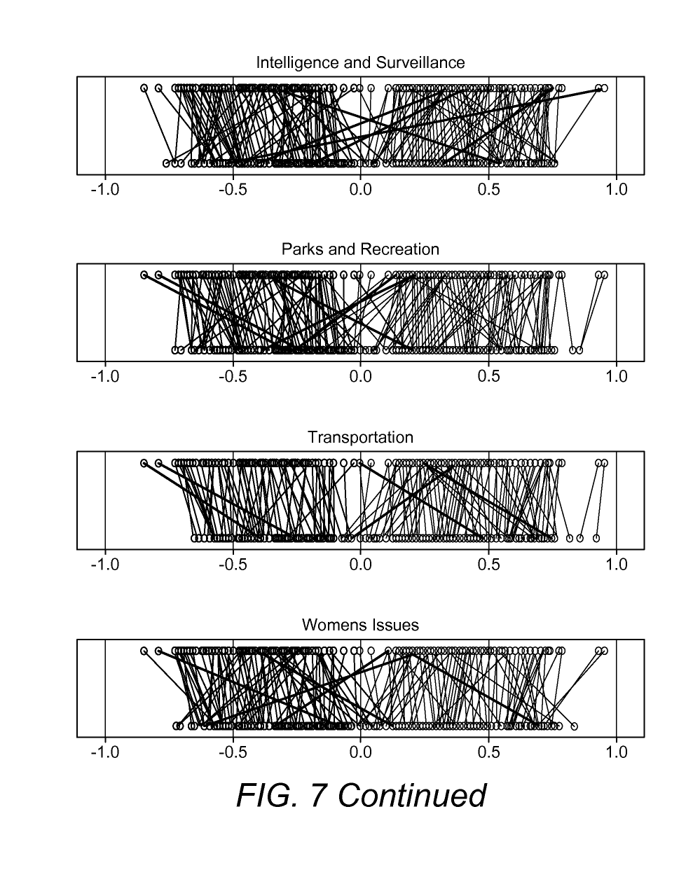

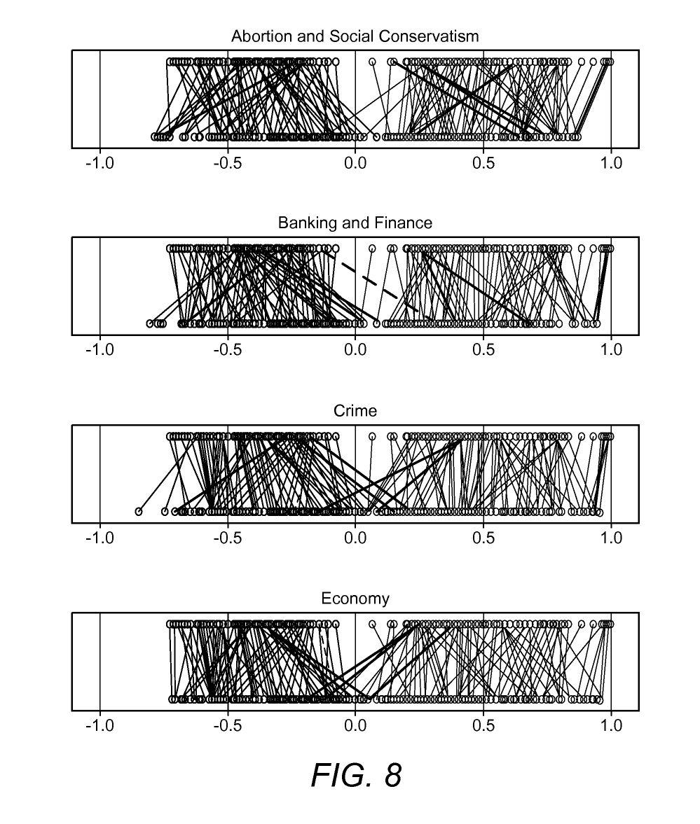

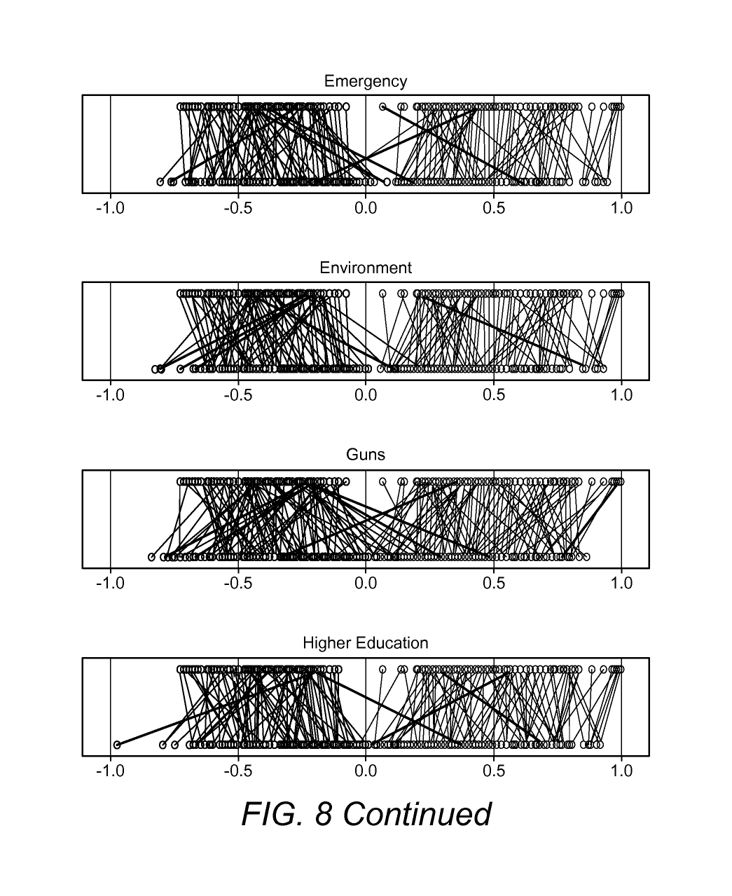

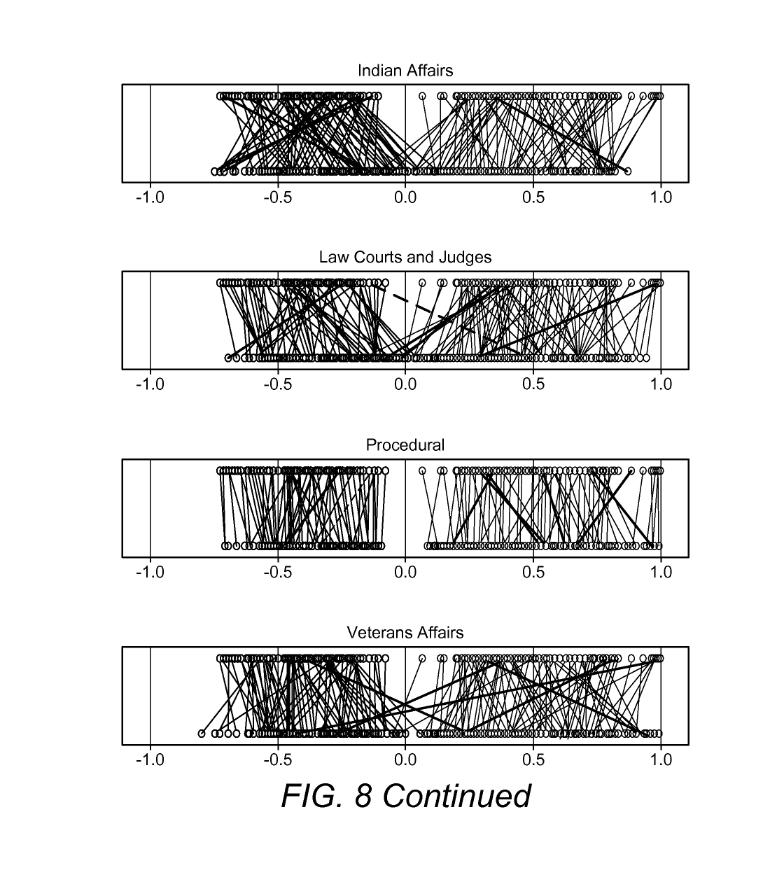

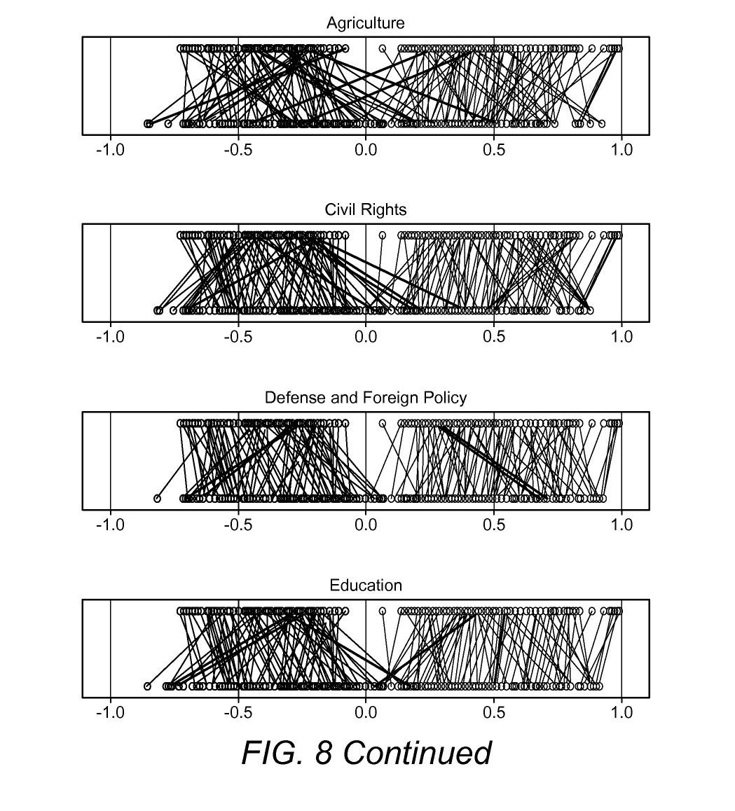

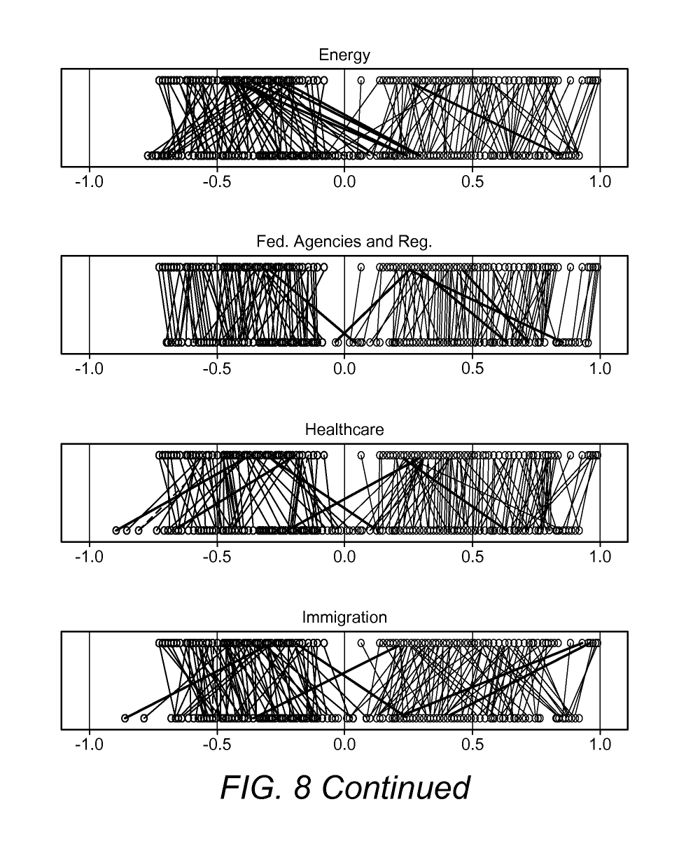

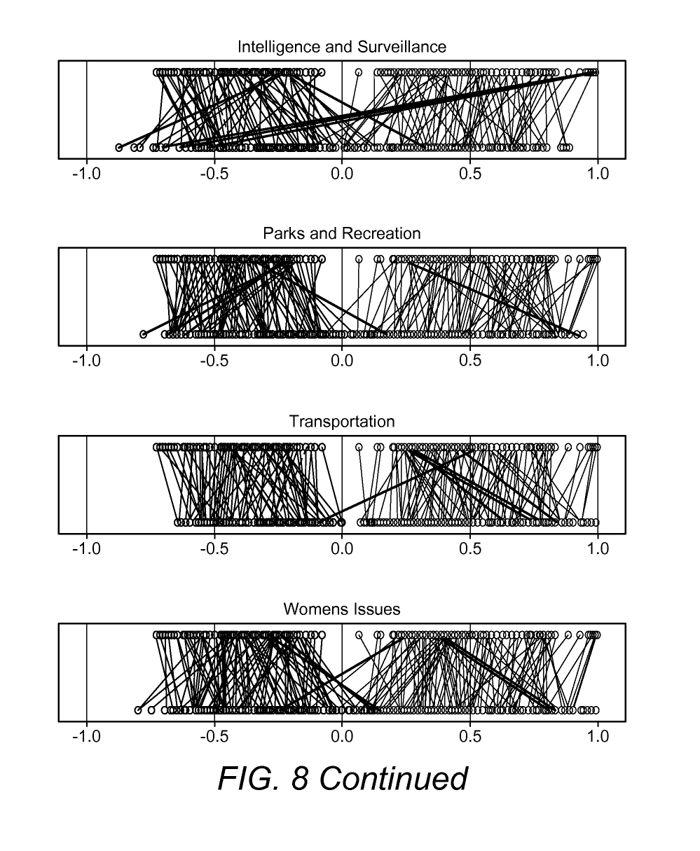

FIGS. 7 and 8 display a series of parallel plot that compare ideal points from classical OC and issue-specific OC for members of the 108th and 113th Congresses, respectively. The points on top are ideal points from a classical one-dimensional OC scaling. The points on the bottom are the corresponding issue-specific ideal points. The line segments trace changes in ideal points between models.

In contrast to the near perfect separation between the parties in Congress in the one-dimensional OC model during the period under analysis, the issue-specific model does show increased partisan overlap for most issues. The issues where this is most apparent are Abortion and Social Conservatism, Agriculture, Guns, Immigration, Indian Affairs, Intelligence and Surveillance and Women's Issues.

Where the issue-specific model excels is in identifying key legislators that break ranks on one or more issue dimensions. For example, the sole legislator to crossover on Defense and Foreign Policy was Jim Leach (R-IA) who was known for his progressive views on foreign affairs. Of the legislators to crossover on Abortion and Social Conservatism, pro-life advocates Ben Nelson (D-NE), John Breaux (D-LA), and Bobby Bright (D-LA) are the three most conservative Democrats and pro-choice advocates Sherry Boehlert (R-NY), Olympia Snowe (R-ME), and Rob Simmons (R-CT) are the three most liberal Republicans. Although legislators who break with their party are few in number for any given issue dimension, they are often noteworthy and highly visible players on the issue area that stand out as examples of cross-pressured bipartisans or uncompromising hardliners. Often the largest differences are associated with legislators who are active on the issue. For example, on Immigration the legislators whose issue-specific ideal points shift them the most from their overall score are Chuck Hagel (R-NE) and Jeff Flake (R-AZ), both of whom had cosponsored bi-partisan immigration reform bills at different points in time.

The issue-specific ideal points on the Intelligence and Surveillance dimension are especially revealing. Four of the most conservative Republicans—Ron Paul (R-TX), Rand Paul (R-KY), Mike Lee (R-UT), and Justin Amash (R-MI)—vote so consistently against their party that they flip to have some of the most liberal ideal points on the issue. This fits with the libertarian leanings of these candidates as well as their public and vocal opposition to government surveillance.

Changes in patterns of partisan overlap from the 108th to 113th Congress can also be revealing. In the 108th, the issue-specific ideal points for a handful of Republicans including Lincoln Chafee (R-RI), George Voinovich (R-OH), Mike Dewine (R-OH), and John Warner (R-VA) accurately place them well to left of center on Guns. By the 113th Congress, the only remaining Republican crossover was Senator Mark Kirk (R-IL), whereas the number of Democrats breaking with their party over gun policy had grown to include Byron Dorgan (D-ND), Henry Cuellar (D-TX), Kurt Schrader (D-TX), Max Baucus (D-MT), Mark Pryor (D-AR), and several others.

The exemplary model further integrates campaign contributions, which can further be used to score political entities on issues and ideology. The exemplary model produces issue-specific ideal points for a vast majority of candidates who lack voting records. In some examples, the model may integrate voting records and contribution records to estimate issue-specific ideal points for the entire population of candidates simultaneously. In addition or instead, the model may rely on supervised machine-learning methods as described below.

The structure of campaign contribution data has many similarities to text-as-data. The contingency matrix of donors and recipients is functionally similar to a document-term matrix, only with shorter documents and more highly informative words. As such, in one example, exemplary models useful for political text can be translated for use with campaign contributions. Although several classes of models typically applied to textual analysis could be used here, an exemplary model discussed here includes support vector regression (SVR) (which is described, for example, in “Support vector regression machines,” Drucker, Harris, Chris J C Burges, Linda Kaufman, Alex Smola, and Vladimir Vapnik, Advances in neural information processing systems 9: 155-161 (1997); and both “A tutorial on support vector regression.” Smola, Alex J, and Bernhard Scholkopf, Statistics and computing 14 (3): 199-222 (2004), both of which are incorporated herein by reference in their entirety).

The SVR approach has several advantages over other models. For example, the SVR approach provides extensibility and generalizability. Further, in other examples, other types of data can be included alongside the contribution data as additional features. The model presented here combines contribution records with word frequencies from the document-term matrix for use as the predictor matrix. Although, contribution data typically performs better than text-as-data when modeled separately, including both data sources boosts cross-validated R-squared by 1-2 percentage points for most issue-dimensions over the contribution matrix alone.

It should be noted that this examples takes the roll call estimates as known quantities despite the presence of measurement error. This can make assessing model fit somewhat problematic as it is unclear the extent to which cross-validation error actually reflects attenuation bias. Although not ideal, in one example, the roll-call estimates are treated as though they are measured without error. (An alternative approach includes training a binary classifier on individual vote choices on bills and then scale the predicted vote choices for candidates using the roll call parameters recovered from OC.)

In one example, the SVR model is fit using a linear kernel and recursive feature selection. To help the model handle the sparsity in the contribution matrix, an n by k matrix can be constructed that summarizes the percentage of funds a candidate raised from donors within different ideological deciles. This can be done by calculating contributor coordinates from the weighted average of contributions made to the set of candidates with roll call estimates for the target issue scale and then binning the coordinates into deciles. The candidate decile shares can then be calculated as the proportion of total funds raised from contributors locating within each decile. When calculating the contributor coordinates, contributions made to candidates in the test set can be excluded so as not to contaminate the cross-validation results. This simple trick helps to augment feature selection. As is typical with support vector machines, the modeling parameters may require careful calibration. For example, the ε and cost parameters can be tuned separately for each issue dimension.

Table 3 (below) shows fit statistics for 15 exemplary issue dimensions for members of the 113th Congress. The cross-validated correlations coefficients are above 0.95 for every issue.

The within party correlations are generally above 0.60, indicating that the model is able to explain variation in the scores of co-partisans.

TABLE 3
Fit Measures from Cross-Validation

| | All Cands | | Dem Cand | | Rep Cands | |
|---|---|---|---|---|---|---|
| | Pearson | RMS | Pearson | RMS | Pearson | RMS |
| | R | E | R | E | R | E |
| Latent | 0.979 | 0.074 | 0.819 | 0.06 | 0.775 | 0.085 |
| Defense And Foreign | 0.973 | 0.085 | 0.732 | 0.073 | 0.74 | 0.094 |
| Policy | | | | | | |
| Banking And Finance | 0.973 | 0.081 | 0.7 | 0.076 | 0.751 | 0.085 |
| Energy | 0.971 | 0.084 | 0.711 | 0.074 | 0.722 | 0.092 |
| Healthcare | 0.97 | 0.091 | 0.76 | 0.078 | 0.741 | 0.1 |
| Economy | 0.968 | 0.089 | 0.687 | 0.081 | 0.721 | 0.095 |
| Environment | 0.966 | 0.094 | 0.68 | 0.089 | 0.732 | 0.095 |
| Women's Issues | 0.964 | 0.094 | 0.619 | 0.083 | 0.687 | 0.101 |
| Education | 0.963 | 0.099 | 0.679 | 0.087 | 0.678 | 0.108 |
| Abortion And Social | 0.961 | 0.102 | 0.637 | 0.096 | 0.691 | 0.107 |
| Conservatism | | | | | | |
| Higher Education | 0.958 | 0.104 | 0.698 | 0.09 | 0.697 | 0.115 |
| Immigration | 0.957 | 0.11 | 0.643 | 0.103 | 0.699 | 0.115 |
| Fair Elections | 0.956 | 0.117 | 0.626 | 0.099 | 0.659 | 0.139 |
| Intelligence And | 0.952 | 0.108 | 0.705 | 0.088 | 0.543 | 0.126 |
| Surveillance | | | | | | |
| Labor | 0.952 | 0.122 | 0.603 | 0.123 | 0.663 | 0.123 |
| Guns | 0.951 | 0.116 | 0.68 | 0.089 | 0.56 | 0.137 |

The SVR model demonstrates the viability of training a machine learning model to learn about candidate issue-positions from contribution records and text. In other examples, ensemble methods may build upon the SVR model, for example, K nearest-neighbor methods or the like, to improve predictive performance.

The exemplary model is able to reliably position candidates along a liberal to conservative dimension and capture meaningful variation in legislator ideal points across issue dimensions. By training on the set of ideal points recovered from the issue-specific OC model, a support vector regression model is used to infer scores for other candidates based on shared sources of data. This modeling strategy demonstrates the viability of training a model to predict how candidates would have likely voted on an issue where they in office using shared sources of data and shows promise for recovering ideal points across issue dimensions.

### Exemplary User Interfaces

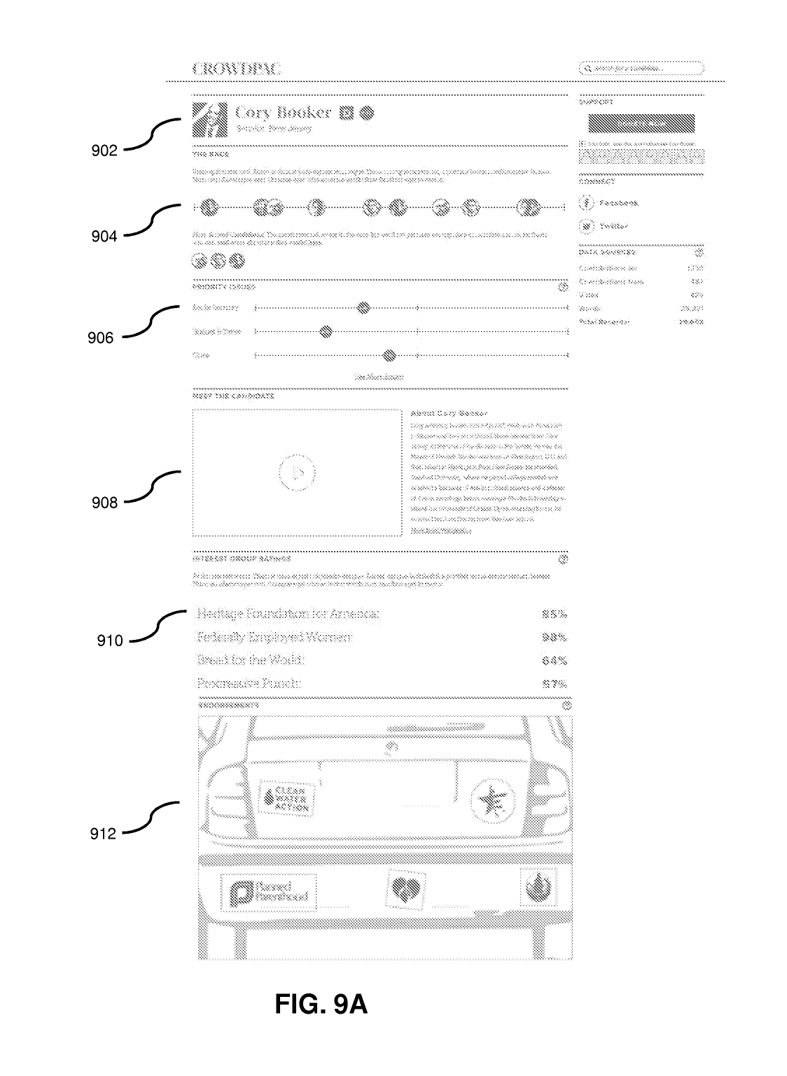

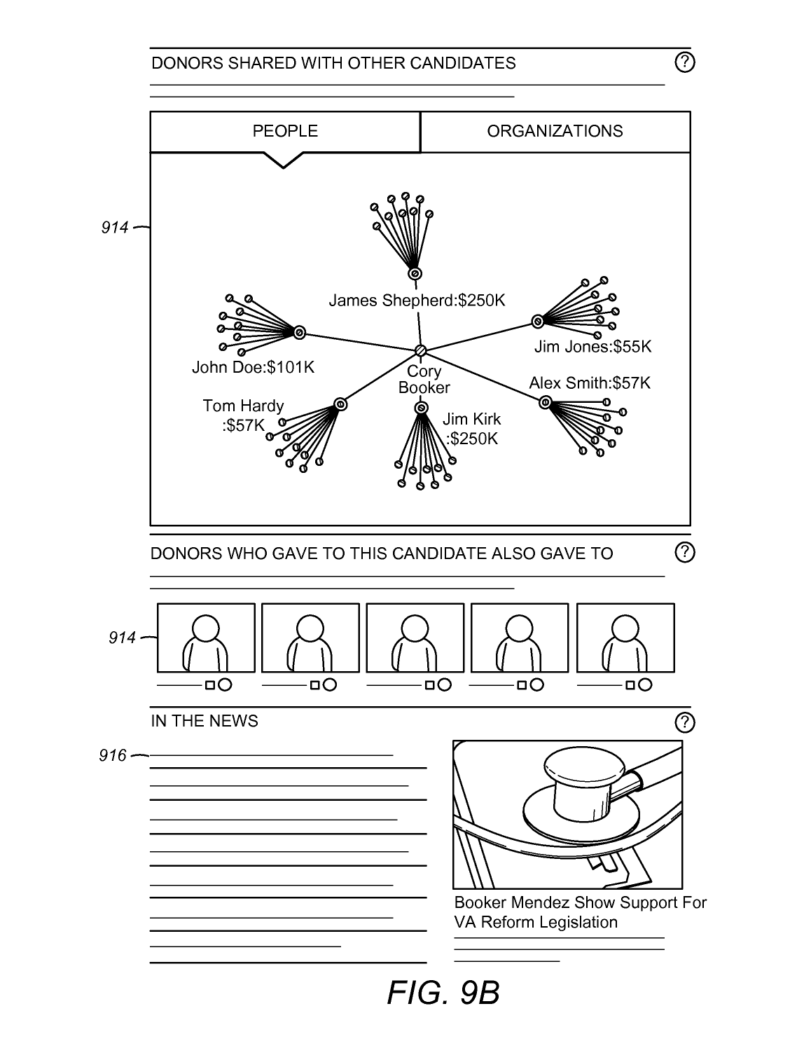

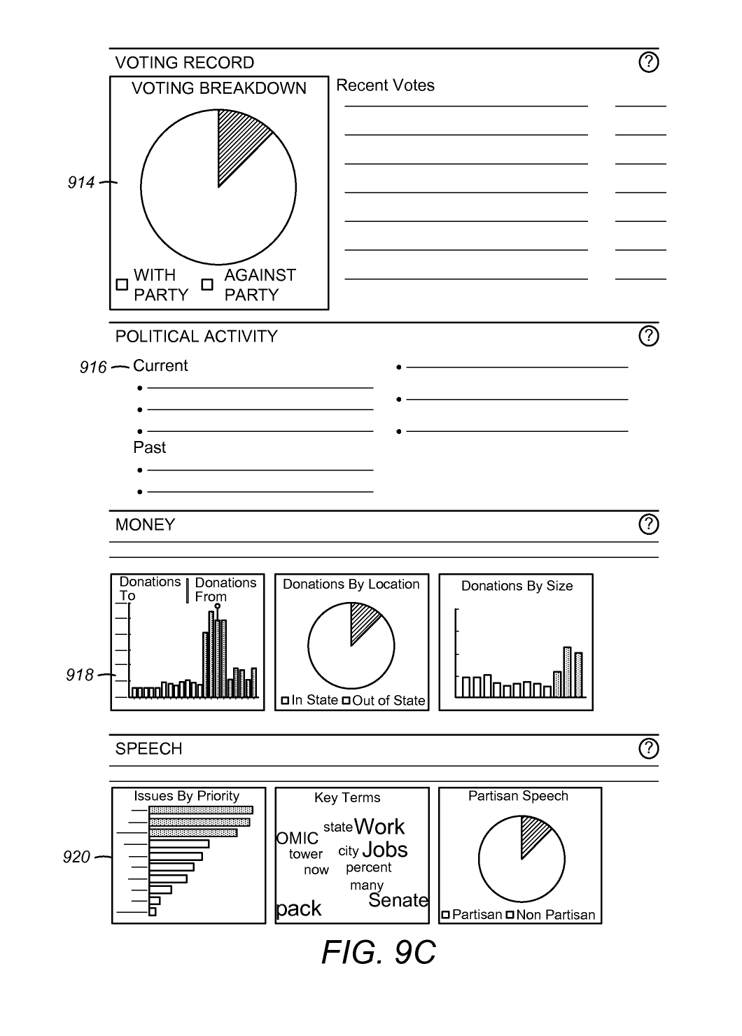

In addition to the exemplary general voter guides illustrated in FIGS. 3 and 4, and discussed above, FIGS. 9A-9C, 10, and 11 illustrate various other features that may be implemented in a user interface leveraging the processes and systems described. With reference initially to FIG. 3, a listing of candidates 302 for different offices can be shown in a single screen, e.g., showing three candidates running for Superintendent, eight candidates running for State Senator, and so on. As described above, each candidate can include a number or score 304 indicating their ideological position on the political spectrum. The user interface can be interactive, where, e.g., hovering over a candidate's image or score may display information such as the candidates top priorities and scores associated therewith. In some examples, the additional information can be shown in a new window, e.g., as shown in FIG. 4, and described above. Further hovering over the scores may provide an explanation of the score, illustrate average scores, indicate other candidates with similar scores, or the like.

FIGS. 9A, 9B, and 9C illustrate another example of a user interface for displaying information relating to political entities. In this example, basic information, including, e.g., the candidate's name, party affiliation, office they are seeking or sitting in, and overall ideological score can be displayed in section 902. Below this an illustration of the race can be displayed at 904, including other candidates running for the same office illustrated along the ideological scoring line. Accordingly, a user can quickly see where other candidates fall relative to the instant candidate per the scoring. Further, each candidate can be shown by a small image representing them, and can further be selectable to display additional information or jump to the candidate's information page. Also, in some instances certain candidates may not be scored because of insufficient data, and can be listed below the scoring line.

Next, a priority issues section 904 can be displayed as described previously with respect to FIG. 4. In some examples, this section might include tabs to show the candidates score relative to the user's identified top priorities, most popular categories, and so on.

Next, information about the candidate can be displayed at 906. For example, a short summary of the candidate, video of the candidate speaking or campaign video, can also be included. Additionally, links to additional news feeds, campaign websites, and so on may be included here (or elsewhere, e.g., section 916). Interest group ratings may also be included at 910, e.g., how an interest group rates the candidate, and endorsements the candidate has received in section 912 (here shown as bumper stickers on a car).

Section 914 includes a graphical representation of donors who have donated to the candidate and what other candidates also received donations therefrom. For example, various donors of the candidate can be selected to show who else the donors gave to and how much. In one example, as a donor is selected the graph “re-centers” on the donor and shows various candidates they donated to. In other examples, similar information can be displayed in a new window or overlaying the interface. A similar graph can also be generated and displayed based on organizations (e.g., companies, super PACs, etc.) that donated to the candidate.

Section 916 may include the latest news articles for the candidate, which may be filtered based on candidate priorities or user preferences.

Further, section 918 can include donor information similar to that discussed with respect to FIGS. 3 and 4 (e.g., displayed in various fashion including by donations to/from, donations by geographical location, size of donations, and so on.

Finally, section 920 can include various data relating to the text or speech data used to score candidates. For example, an indication of important issues, key words, word clouds, partisan v. non-partisan speech, and the like can be graphically shown.

It should be recognized that a candidate's page can be arranged in other fashions, including different, fewer, or more sections/modules. Further, various metrics and information can be displayed or presented in other fashions as will be understood by those of ordinary skill in the art.

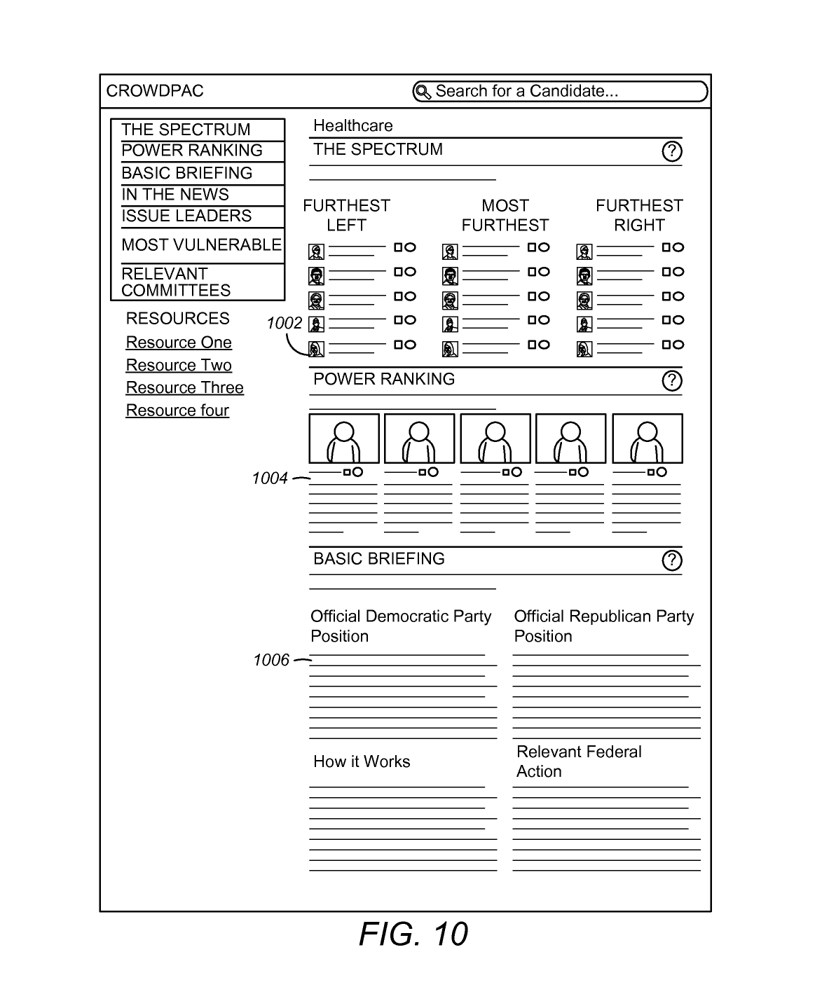

FIG. 10 illustrates another user interface that can be generated based on some of the data discussed herein. In this example, a user can select a topic or issue, e.g., healthcare, social security, guns, military spending, and so on. Each page can display the ideological positions of various political entities on the issue, as well as other content. For example, section 1002 may display the relative position of different political candidates on the particular issue, here including the farthest left, moderate and furthest right candidates on the issue. Again, in some examples each candidate can be selectable to display additional information or to jump to their candidate page.

Section 1004 further includes a power ranking of different candidates, which, in one example, are derived from information from Congressional Quarterly. This may include quantitative or subject rankings of candidates.

The issue page can further include a section 1006 that summarizes issues, party positions, and so on, followed by a news crawler section or the like. Other display elements such as an ideological spectrum can also be displayed for the various political entities relating to the selected issue.

Additionally, a most vulnerable candidate section may be included, which identifies candidates who are in competitive races and where contributions are the most likely to be pivotal.

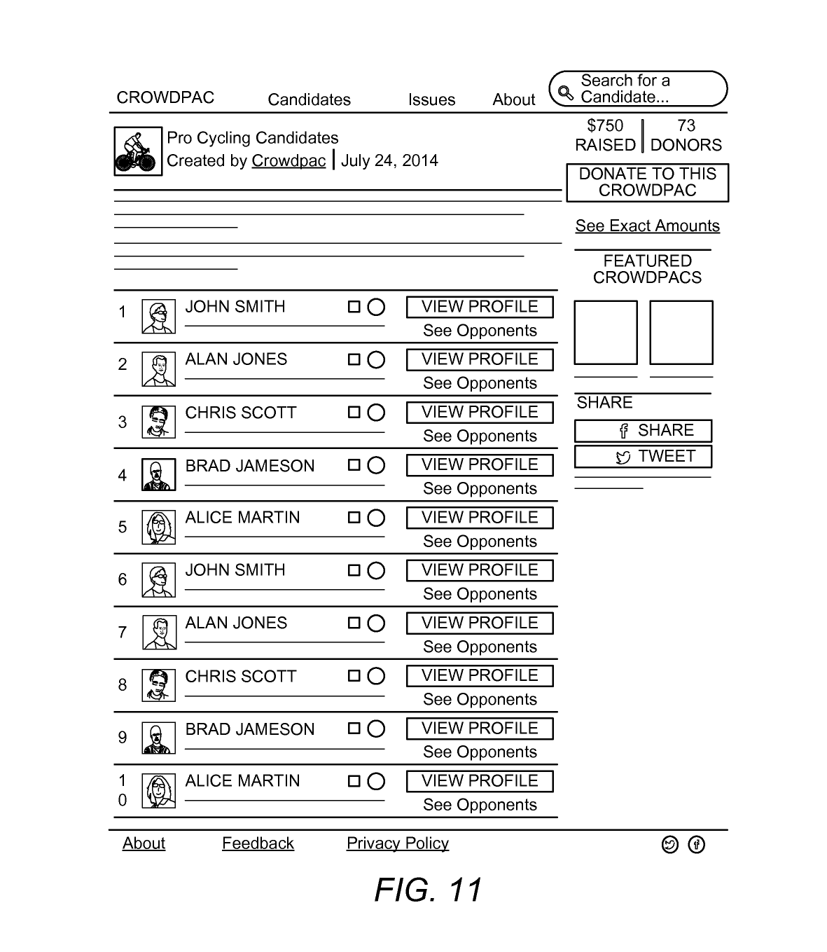

FIG. 11 illustrates an exemplary user interface for a donation page, which can be based or filtered on a user selected political issue. For example, a user may enter an issue they care about, in this example, a search for candidates that are pro “Cycling.” The user interface can then return a list of the most pro “Cycling” candidates according to the scoring on this issue, e.g., based on processed text data and contribution data. The candidate list could further be filtered based on party or the user's top priorities and issues to return a list of candidates that are both pro “Cycling” and also meeting some basic matching to the user's interest. From this page, a user can view information on the candidates, jump to a candidates full profile page, or make donations to the candidates. In one example, the user could select a donation to all candidates scoring above a threshold for the particular issue of interest.

Various other features may be integrated with a user interface as described herein. For instance, in some examples, a user may create social connections within the application (or a separate application, such as Facebook, LinkedIn, Twitter, etc.), and be allowed to view information relating to the other users. For example, a first user may be able to view a second user's top priority issues, candidates they support, donations they have made (to candidates or issues), and the like.

FIG. 12 depicts an exemplary computing system 1400 configured to perform any one of the above-described processes, including the various scoring models and generation of user interfaces. In this context, computing system 1400 may include, for example, a processor, memory, storage, and input/output devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 14 depicts computing system 1400 with a number of components that may be used to perform the above-described processes. The main system 1402 includes a motherboard 1404 having an input/output (“I/O”) section 1406, one or more central processing units (“CPU”) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

What is claimed is:

1. A computer-implemented method for retrieving information on political entities, the method comprising:
at an electronic device having at least one processor and memory:
receiving a request for information on a political entity;
causing the display of a graphical element associated with the political entity, the graphical element indicating an ideological score, wherein the ideological score is derived from text data and contribution data associated with the political entity.

2. The computer-implemented method of claim 1, wherein the political entity is a candidate for elected office.

3. The computer-implemented method of claim 1, wherein the ideological score is based on the source of the donations to the political entity.

4. The computer-implemented method of claim 1, wherein the ideological score is further based on donations made by the political entity.

5. The computer-implemented method of claim 1, wherein the ideological score is further based on a legislative voting record associated with the political entity.

6. The computer-implemented method of claim 1, wherein the graphical element includes a visualization of the candidates fundraising network.

7. The computer-implemented method of claim 1, wherein the graphical element includes a summary of the text associated with the political entity.

8. The computer-implemented method of claim 1, wherein the graphical element includes a tag cloud associated with the political entity.

9. A user interface for retrieving information on political entities, the user interface comprising:
receiving, at a computer device, a request for information on a political entity;
displaying a graphical element associated with the political entity, the graphical element indicating an ideological score, wherein the ideological score is derived from text data and contribution data associated with the political entity.

10. The user interface of claim 9, wherein the political entity is a candidate for elected office.

11. The user interface of claim 9, wherein the ideological score is based on the source of the donations to the political entity.

12. The user interface of claim 9, wherein the ideological score is based on text associated with the political entity.

13. The user interface of claim 9, wherein the ideological score is based a legislative voting record associated with the political entity.

14. The user interface of claim 9, wherein the graphical element includes a visualization of the candidates fundraising network.

15. The user interface of claim 9, wherein the graphical element includes a summary of the text associated with the political entity.

16. The user interface of claim 9, wherein the graphical element includes a tag cloud associated with the political entity.

17. A non-transitory computer-readable storage medium comprising computer-executable instructions for:
receiving a request for information on a political entity;
displaying a graphical element associated with the political entity, the graphical element indicating an ideological score, wherein the ideological score is derived from text data and contribution data associated with the political entity.

18. A system comprising:
one or more processors;
memory; and
one or more programs, wherein the one or more programs are stored in the memory and configured to be executed by the one or more processors, the one or more programs including instructions for:
receiving a request for information on a political entity;
displaying a graphical element associated with the political entity, the graphical element indicating an ideological score, wherein the ideological score is derived from text data and contribution data associated with the political entity.
